(19) United States
(12) Patent Application Publication
(10) Pub. No.: US 2026/0217379 A1
(43) Pub. Date: Jul. 30, 2026

(54) DRIVE DEVICE FOR AN AIRCRAFT WITH A CASING DEVICE FOR AIR GUIDING

(71) Applicant: ROLLS-ROYCE DEUTSCHLAND LTD & CO KG, Blankenfelde-Mahlow (DE)

(72) Inventors: Uwe Peter ZEECK, Berlin (DE); Andreas FRÖDE, Neuenhagen (DE)

(73) Assignee: ROLLS-ROYCE DEUTSCHLAND LTD & CO KG, Blankenfelde-Mahlow (DE)

(21) Appl. No.: 19/145,328

(22) PCT Filed: Jan. 4, 2024
(86) PCT No.: PCT/EP2024/050150

§ 371 Date: Jul. 2, 2025

(30) Foreign Application Priority Data
Jan. 10, 2023 (DE) 10 2023 100 437.9
Jun. 1, 2023 (DE) 10 2023 114 464.2

(51) Int. Cl. B64D 33/08; B64C 29/00; B64D 27/34; B64D 33/02

(52) U.S. Cl. CPC B64D 33/08; B64C 29/0016; B64D 27/34; B64D 33/02; B64D 2033/024; B64D 2033/0253

(57) ABSTRACT

The invention relates to a drive device (30) for an aircraft with a casing device (1) for air guiding, characterised in that the casing device (1) surrounds the drive device (30) at least partially in the peripheral direction, wherein the casing device (1) has a periodic profiling (10) running in the peripheral direction, wherein the open cross-section of the profiling (10) is orientated at least partially perpendicular to the direction of flight (F) of the aircraft, and a flow guiding device (31) running in the peripheral direction, which radially divides the cross-section of the profiling (10) into two parts, wherein a first profiling region (11) has at least one first opening (21) of a first air guiding channel (23), and a second profiling region (12) has at least one section opening (22) of a second air guiding channel (24), and air can be guided into the drive device (3) using the at least one first air guiding channel (23) and air can be guided out of the drive device (30) using the at least one second air guiding channel (24).

The invention relates to a drive device for an aircraft having the features of claim 1.

Drive devices for aircraft need to be cooled, and this need can be met in particular by air flowing around the drive device. Electric drives, especially for vertical take-off and landing (eVTOL) aircraft, are compact, such that only a small amount of space remains for efficient cooling devices.

Conventional propeller drives use in particular separate coolers in scoops. In radial engines, use was made of air inlets in the region of the axis of rotation.

The object is to create drive devices that allow efficient air guiding.

The object is achieved by a drive device having the features of claim 1.

The drive device here has a casing device which surrounds the drive device at least partially in the circumferential direction, wherein the casing device has a profiling which runs around periodically in the circumferential direction, wherein the open cross section of the profiling is oriented at least partially perpendicularly to the direction of flight of the aircraft. The open cross section is the profiled, for example deformed, region pointing in the direction of flight on the casing device.

A flow-directing device, which runs around in the circumferential direction of the casing device, serves to divide the cross section of the profiling radially into two parts, that is to say an outer part and an inner part.

The profiling here has two regions, namely a first profiling region having at least one first opening in a first air-guiding channel and a second profiling region having at least one second opening in a second air-guiding channel. The profiling regions are coupled to air-guiding channels such that air can flow in through the openings thereof.

By way of the at least one first air-guiding channel, air can be guided into the inside of the drive device and, by way of the at least one second air-guiding channel, air can be guided out from the inside of the drive device.

The profiling, which runs periodically around the casing device, thus enables, for example, both cooling air to be guided into the inside of the drive device and the heated air to be discharged again with the same profiling.

In one embodiment, in the cross section perpendicular to the direction of flight, the periodic profiling can be, at least in some portions, wave-shaped, in particular sinusoidal, triangular and/or rectangular. All of these cross-sectional shapes make it possible, when arranged on the casing device, for the flow-directing device to divide this casing device into two profiling regions, such that the supply and discharge of air can be accomplished in a simple manner.

Thus, the flow-directing device can be in particular ring-shaped, wherein it is oriented at least partially parallel to the direction of flight. A narrow side of the ring can then point, for example, in the direction of flight, such that the air can flow along the outer side and inner side of the ring-shaped flow-directing device into the openings in the air-guiding channels.

In one embodiment, the profiling can have two cross sections which run around periodically and are arranged so as to be offset from each other. Thus, for example, the front side and the rear side of the profiling can each have a sinusoidal contour, although the sinusoidal contours are arranged so as to be shifted with respect to each other (for example by) 180°.

In one embodiment, the flow-directing device can also be deformed in one direction, in particular in the radial direction, in the region of the first opening, such that the effective cross-sectional area for incoming air is enlarged. Thus, for example, the flow-directing device can be deformed radially inwardly in front of the first openings in order to create a larger cross section for the air.

In another embodiment, the flow-directing device can have a channeling means in the region of the second opening, such that air can be guided in a targeted manner out of the inside of the drive device through the second opening. The channeling means can serve, for example, to direct the air in a targeted manner out from the inside of the drive device to the second openings.

To ensure that the drive device is internally cooled, the air flowing in through the at least one first air-guiding channel can be guided into an air collection chamber of the drive device. The air collection chamber can be an individual cavity or the cavity that comprises internal assemblies of the drive device. For example, the air that has flowed into the air collection chamber can be guided via an opening in the air collection chamber to the second opening in the at least one second air-guiding channel. Additionally or alternatively, air flowing out of the air collection chamber can also be usable as cooling air for a part of the drive device.

To keep production simple, a part of the casing device can be formed from a rectangular flat material, wherein the profiling is arranged in an edge region of the flat material that is oriented in the direction of flight.

The drive device can have a propeller drive, in particular an electrically driven propeller drive with a rear cooling intake. This drive device can be used in particular in urban air mobility (UAM) aircraft. For this purpose, the drive device can be coupleable in particular to an, in particular electrically driven, vertical take-off and landing aircraft.

The invention will be explained in conjunction with the exemplary embodiments illustrated in the figures, in which

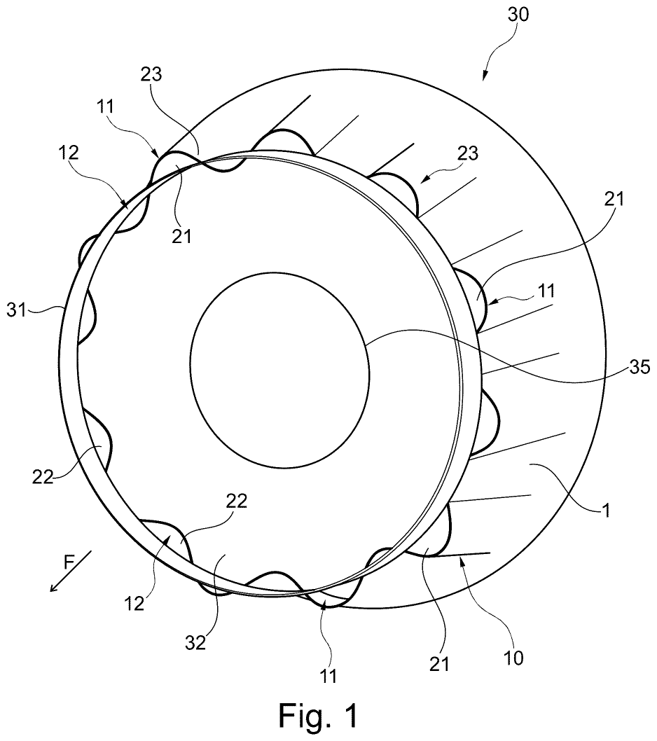

FIG. 1 shows a schematic perspective view of a first embodiment of a drive device;

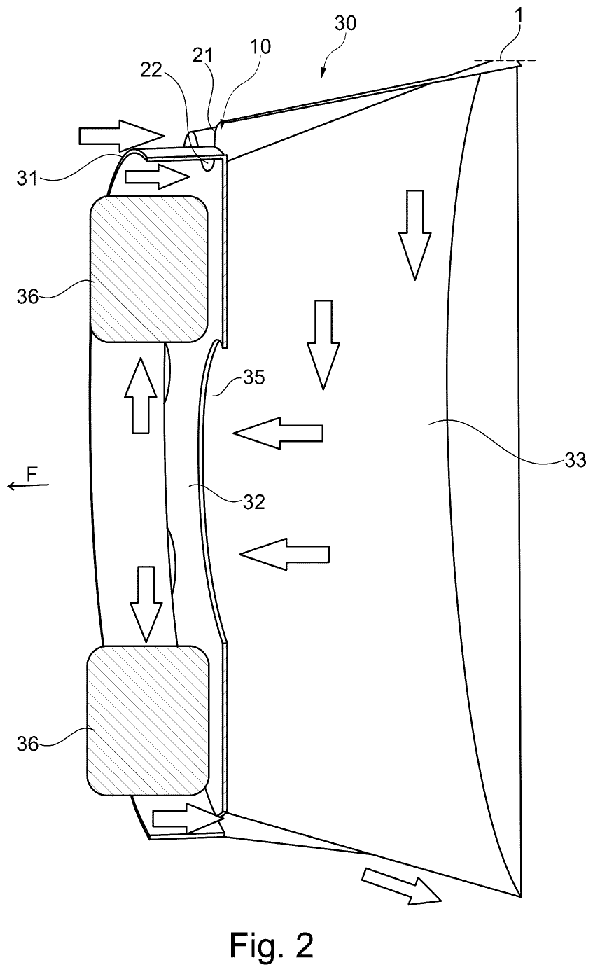

FIG. 2 shows a schematic sectional view of the embodiment from FIG. 1;

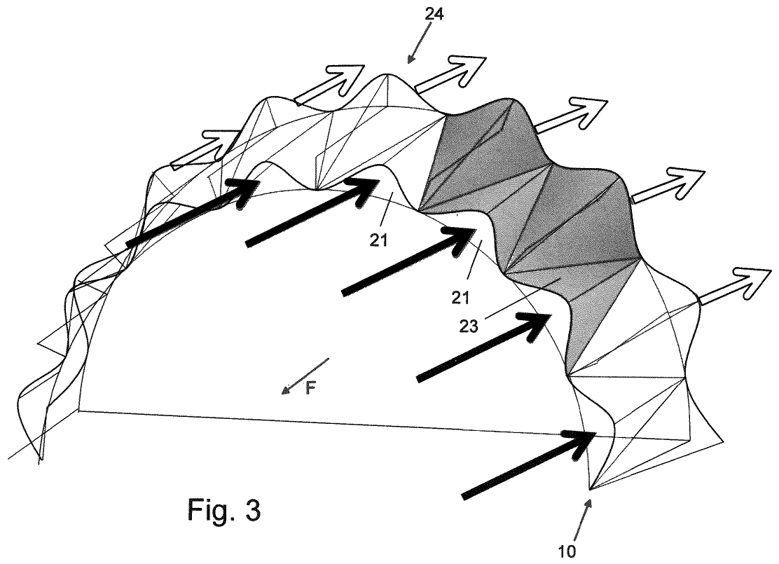

FIG. 3 shows a schematic partial view of a second embodiment of a drive device;

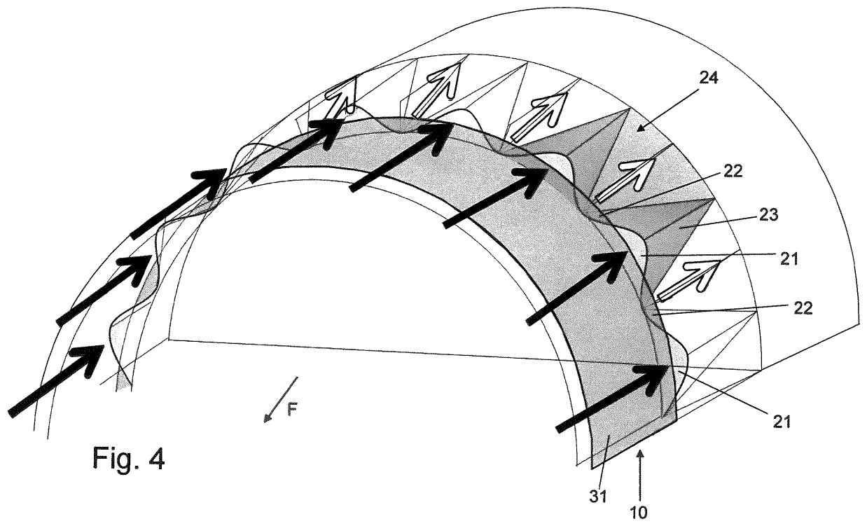

FIG. 4 shows a schematic partial view of a third embodiment of a drive device;

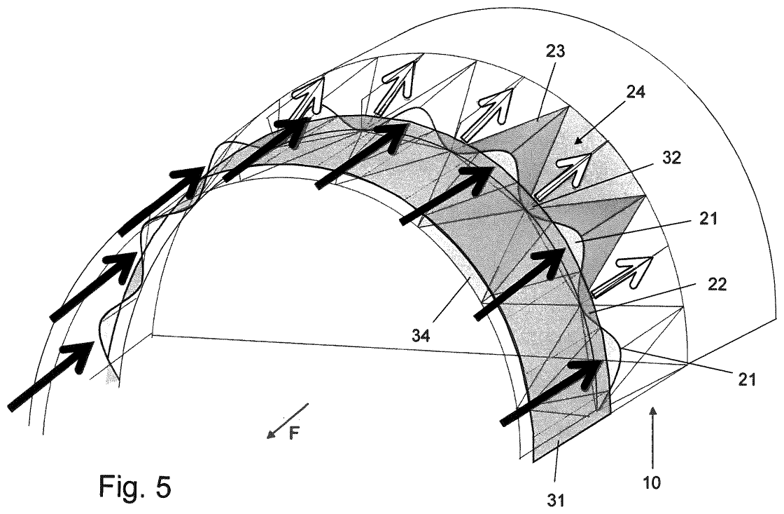

FIG. 5 shows a schematic partial view of a fourth embodiment of a drive device;

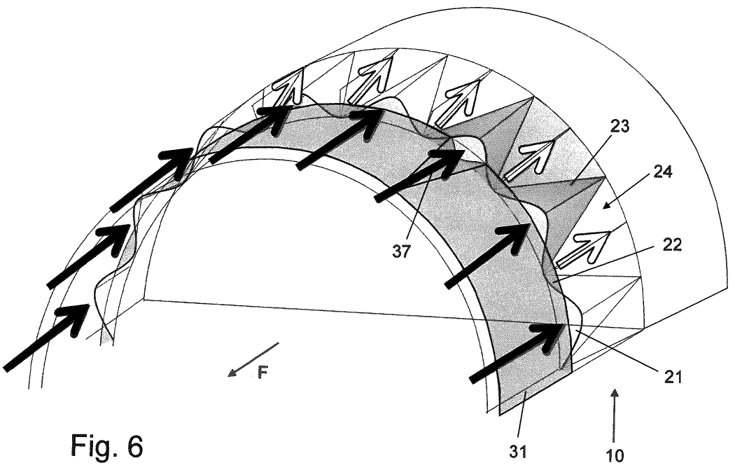

FIG. 6 shows a schematic partial view of a fifth embodiment of a drive device;

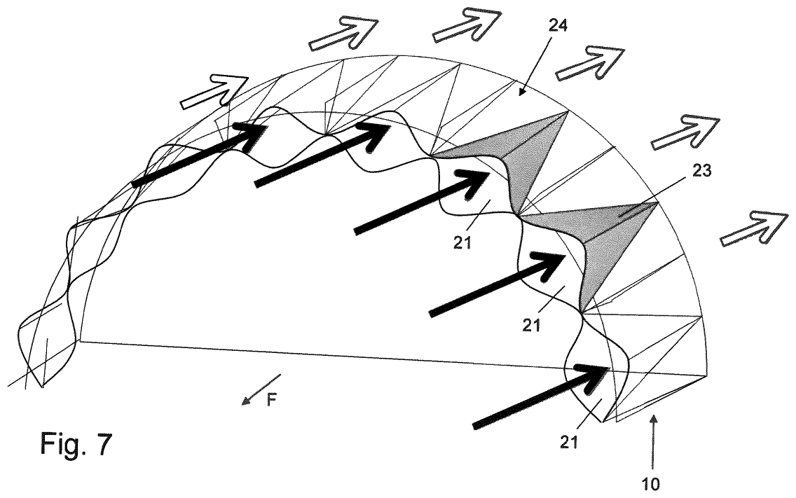

FIG. 7 shows a schematic partial view of a sixth embodiment of a drive device.

FIG. 1 schematically illustrates a front view of a drive device 30—here, an electric drive device 30—which is known per se. For reasons of clarity, the propeller is not illustrated here. Also, only that part of the drive device 30 which lies directly behind the plane of rotation of the propeller is shown.

During operation of the drive device 30, the direction of flight F points in the direction of the axis of rotation of the propeller.

In the following, the focus is primarily on the guidance of air that flows in onto the drive device 30 from the front (that is to say counter to the direction of flight F) during operation.

In order to guide the air, the drive device 30 has a casing device 1 which completely surrounds the drive device 30 in the circumferential direction. In other embodiments not illustrated here, the casing device 1 extends only over a part of the circumference of the drive device 30.

The casing device 1 has a profiling 10 which runs around periodically in the circumferential direction, wherein the open cross section of the profiling 10 is oriented at least partially perpendicularly to the direction of flight F of the aircraft.

The profiling 10 here is arranged on the front edge of the casing device 1. A sinusoidal wave profiling, which can be efficiently produced, is impressed into this front edge. For this purpose, a longitudinal edge of, for example, a rectangular metal sheet has to be provided with such a wave profiling, for example by means of pressing. Then, the metal sheet can be joined to form a ring, the casing device 1 (or at least a part thereof) with the profiling 10 being formed as a result.

Thus, the peaks of the periodic profiling 10 protrude radially outwardly, while the valleys of the profiling 10 point radially inwardly.

The cross section of the profiling 10 is understood here to mean the deformed part of the casing device 1, this part being oriented in the direction of flight F. Since the profiling 10 is sinusoidal, the cross section of the profiling is a ring-shaped region having a radial extent with a width of double amplitude.

A flow-directing device 31, which runs around in the circumferential direction, is arranged in front of this profiling 10 and divides the cross section of the profiling 10 into two parts: a radially inner part and a radially outer part. The flow-directing device 31 is designed here as a directing element (see FIG. 2) lying substantially horizontally and parallel to the direction of flight F, i.e. it is designed as a ring, a flat side of which is oriented counter to the direction of flight F.

The peaks of the wave-shaped profiling 10 lie in the radially outer part, and the valleys of the profiling 10 lie in the radially inner part.

Thus, a first profiling region 11, which has a multiplicity of first openings 21 in first air-guiding channels 23, lies in the radially outer part. The first air-guiding channels 23 are arranged below the radial bulges visible here and are more easily visible in FIGS. 2 to 7.

The first openings 21 form inlet openings for the air that flows onto the drive device 30 from the front during operation.

A second profiling region 12, which has a multiplicity of second openings 22 in air-guiding channels 24, lies in the radially inner part. The second air-guiding channels 24 here are the valleys between the bulges of the first air-guiding channels 24. These are also more easily visible in FIGS. 2 to 7.

By way of such an arrangement, air can be guided into the inside of the drive device 30 via the multiplicity of first air-guiding channels 23 (see FIG. 2). At the same time, by way of the multiplicity of second air-guiding channels 24, air can be guided out from the inside of the drive device 30.

The profiling 10 in conjunction with the flow-directing device 31 thus offers, in particular for cooling purposes, an efficient possible way of guiding air into and out of the drive device 30.

One application of the embodiment according to FIG. 1 is illustrated in FIG. 2.

In this sectional view, the multiplicity of openings 21, 22 in the air-guiding channels 23, 24 is illustrated on the front side of the casing device 1.

From the front side of the drive device 30, cool air (light-colored arrows) flows into the first openings 21 in the first profiling region 12. These openings lie radially outside of the flow-directing device 31, wherein the air is guided through the first air-guiding channels 23 into an air collection chamber 33 in the inside of the drive device 30.

The air collection chamber 33 is delimited to the front by a ring-shaped wall 32, which is connected radially outwardly to the flow-directing device 31. The air collection chamber 33 is delimited to the rear by another wall or assemblies in the inside of the drive device 30.

An opening 35, from which cool air from the air collection chamber 33 can flow forward in the direction of the propeller (not illustrated here), is arranged in the central region of the wall 32.

The air flowing out centrally then subsequently flows radially outwardly and heats up on the drive assemblies 36. The hot air (light-colored arrows) then flows rearward, counter to the direction of flight F, on the radially inner side of the flow-directing device 31, to be precise it flows through the second openings 22 in the second profiling region 12. The second air-guiding channels 24 then guide the hot air outward, i.e. onto the outer side of the drive device 30.

Thus, by means of the periodic profiling 10 on the casing device 1, it is simultaneously possible for cool air to be guided into the drive device 30 and for heated air to be discharged out of the drive device 30.

In the embodiment according to FIGS. 1 and 2, the profiling 10 has a contour with a sine shape. This runs rearward into the casing device 1, which has a substantially circular cross section.

In alternative embodiments—not illustrated here—the profiling 10, which runs around periodically, can also have another shape. For example rectangular contours or triangular contours are conceivable. In principle, it is also possible to use different contours along the circumference of the drive device 30. These profilings 10 can also be subdivided into two radial parts by the flow-directing device 31, such that inner and outer openings 21, 22 are achieved.

In FIGS. 3 to 7, a respective segment of the profiling 10 is illustrated in different embodiments, such that in particular other parts of the drive device 30 are not illustrated. Otherwise, the description of the first embodiment (FIGS. 1 and 2) can be applied analogously.

FIG. 3 shows a second embodiment of a drive device 30 with a profiling 10, the front edge of which has a sinusoidal contour, as in the first embodiment. However, in contrast to the first embodiment, the rear part of the profiling 10 does not transition smoothly into the casing device 1; rather, it also has a sinusoidal contour, the peaks of the rear contour being arranged in the region of the valleys of the front contour, such that an alternating wave structure r is achieved. Thus, two cross sections which run around periodically and are offset from each other are present.

The incoming cool air (dark-colored arrows) enters the openings 21 in the first air-guiding channels 23. The first profiling region is thus shown in FIG. 3.

The outgoing air (light-colored arrows) exits from the second air-guiding channel 24, wherein the guidance of the air in the inside of the drive device 30 can correspond to the first embodiment.

FIG. 4 shows a third embodiment of a drive device 30, wherein the flow-directing device 31 is illustrated here in front of the profiling 10. The second air-guiding channels 24 transition here at the rear part of the profiling 10 into a ring-shaped region of the casing device 1.

Some of the wave peaks which form the first openings 21 are blocked radially within the flow-directing device 31, such that only air radially outside of the flow-directing device 31 can enter the first openings 21.

The fourth embodiment, which is illustrated in FIG. 5, is a modification of the third embodiment, although the lower inlet regions are not blocked. Rather, the flow-directing device 31 has a channeling means 34 in the form of walls which converge in the direction of the second openings 22. Thus, the heated air (light-colored arrows) can be guided into the second air-guiding channels 24 with low pressure loss.

The fifth embodiment, which is illustrated in FIG. 6, has a deformation 37 in the flow-directing device 31, the deformation being arranged in front of the first openings 21. The deformation 37 here points radially inwardly, such that the effective cross section for the air flowing in is enlarged. For reasons of clarity, this deformation is illustrated here only in front of one first opening 21.

The sixth embodiment, which is illustrated in FIG. 7, has a flow-directing device 31 which is designed in two parts.

### LIST OF REFERENCE SIGNS

1 Casing device
10 Profiling
11 First profiling region
12 Second profiling region
21 First opening in the first profiling region
22 Second opening in the second profiling region
23 First air-guiding channel
24 Second air-guiding channel
30 Drive device
31 Flow-directing device
32 Wall
33 Air collection chamber
34 Channeling means
35 Opening
36 Drive assemblies
37 Deformation in flow-directing device
F Direction of flight

1. A drive device for an aircraft with a casing device for air guiding,
wherein
the casing device surrounds the drive device at least partially in the circumferential direction, wherein the casing device has a profiling which runs around periodically in the circumferential direction, wherein the open cross section of the profiling is oriented at least partially perpendicularly to the direction of flight of the aircraft, and
a flow-directing device, which runs around in the circumferential direction and divides the cross section of the profiling radially into two parts, wherein
a first profiling region of the profiling has at least one first opening in a first air-guiding channel, and
a second profiling region of the profiling has at least one second opening in a second air-guiding channel, and,
by way of the at least one first air-guiding channel, air can be guided into the inside of the drive device and, by way of the at least one second air-guiding channel, air can be guided out from the inside of the drive device.

2. The drive device as claimed in claim 1, wherein, in the cross section perpendicular to the direction of flight, the periodic profiling is, at least in some portions, wave-shaped, in particular sinusoidal, triangular and/or rectangular.

3. The drive device as claimed in claim 1, wherein the flow-directing device is ring-shaped, wherein it is oriented at least partially parallel to the direction of flight.

4. The drive device as claimed in claim 1, wherein the profiling has two cross sections which run around periodically and are arranged so as to be offset from each other.

5. The drive device as claimed in claim 1, wherein the flow-directing device is deformed in one direction, in particular in the radial direction, in the region of the first opening, such that the effective cross-sectional area for incoming air is enlarged.

6. The drive device as claimed in claim 1, wherein the flow-directing device has a channeling means in the region of the second opening, such that air can be guided in a targeted manner out from the inside of the drive device through the second opening.

7. The drive device as claimed in claim 1, wherein air flowing in through the at least one first air-guiding channel can be guided into an air collection chamber of the drive device.

8. The drive device as claimed in claim 7, wherein air that has flowed into the air collection chamber can be guided via an opening in the air collection chamber to the second opening in the at least one second air-guiding channel.

9. The drive device as claimed in claim 7, wherein air flowing out of the air collection chamber can be used as cooling air for a part of the drive device.

10. The drive device as claimed in claim 1, wherein the casing device is formed from a rectangular flat material, wherein the profiling is arranged in an edge region oriented in the direction of flight.

11. The drive device as claimed in claim 1, wherein it has a propeller drive, in particular an electrically driven propeller drive, with a rear cooling intake.

12. The drive device as claimed in claim 1, wherein it can be coupled to an, in particular electrically driven, vertical take-off and landing aircraft.
